(19) United States
(12) Patent Application Publication
(10) Pub. No.: US 2016/0047496 A1
(43) Pub. Date: Feb. 18, 2016

(54) Insulated Pipeline Support

(71) Applicant: Leslie O'Connell, Alberta (CA)

(72) Inventor: Leslie O'Connell, Alberta (CA)

(21) Appl. No.: 14/589,162

(22) Filed: Jan. 5, 2015

(30) Foreign Application Priority Data
Aug. 18, 2014 (CA) 2859483

(51) Int. Cl. F16L 3/24; F16L 3/127; F16L 3/08

(52) U.S. Cl. CPC F16L 3/24; F16L 3/08; F16L 3/127

(57) ABSTRACT

A pipeline support for securing an elevated pipeline to a piling is provided. The pipeline support electrically insulates the pipeline from the piling without using an insulating block disposed between the pipeline support and the piling. The pipeline support is also moveable relative to the piling to move along with the thermal expansion and contraction of the pipeline. The pipeline support includes a pipe shoe and a pipeline clamp attached to the pipe shoe. A coating of an electrical insulator material substantially covers the pipeline clamp and an upper half of the pipe shoe.

### CROSS-REFERENCE TO RELATED APPLICATIONS

This application claims the benefit of Canadian Patent Application No. CA2859483, filed Aug. 18, 2014.

### FIELD OF THE INVENTION

The present invention relates generally to pipeline supports, and more particularly, relating to insulated pipeline supports.

### BACKGROUND OF THE INVENTION

In some instances, elevated or above-ground pipelines are desired to transport material between locations as opposed to buried or below-ground pipelines. Elevated pipelines are supported above-ground by pilings that are spaced along the pipeline. Pipeline supports are used to secure sections of the elevated pipelines to the pilings. A basic pipeline support is mounted to a piling and includes a structure that engages the pipeline and secures the pipeline to the piling. A more advanced pipeline support is constructed such that the pipeline support is able to move relative to the piling along with the thermal expansion and contraction of the pipeline.

Conventional pipeline supports have limitations. For instance, most conventional pipelines supports have complex designs, making installing and servicing expensive. And require an insulating block to be positioned between the pipeline support the piling to electrically insulate the pipeline from the piling. Insulating blocks frequently become displaced by the thermal expansion and contraction of the pipeline and pipeline vibrations. Once the insulating block is displaced, the pipeline is dangerously exposed to electrical grounding with the piling and is loosely supported by the pipeline support, which can damage the pipeline and require expensive repair.

What is needed is a pipeline support that provides electrical insulation without using separate insulating blocks and is moveable along with the thermal expansion and contraction of the pipeline.

### SUMMARY OF THE INVENTION

The present invention addresses the needs described above and is directed to an insulating pipeline support that is moveable along with the thermal expansion and contraction of a pipeline without using separate insulating blocks.

In general, in one aspect, an insulating pipeline support according to an embodiment of the invention includes a pipe shoe and a pipeline clamp attached to the pipe shoe. A coating of an electrical insulator material substantially covers the pipeline clamp and an upper half of the pipe shoe.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

In the drawings:

FIG. 1 is an illustrative, perspective view of an insulating pipeline support that is constructed in accordance with the principles of an embodiment of the present invention and in use securing a pipeline section to a piling;

FIG. 2 is an illustrative, front view of the insulating pipeline support of FIG. 1;

FIG. 3 is an illustrative, side view of the insulating pipeline support of FIG. 1.

### DETAILED DESCRIPTION OF THE INVENTION

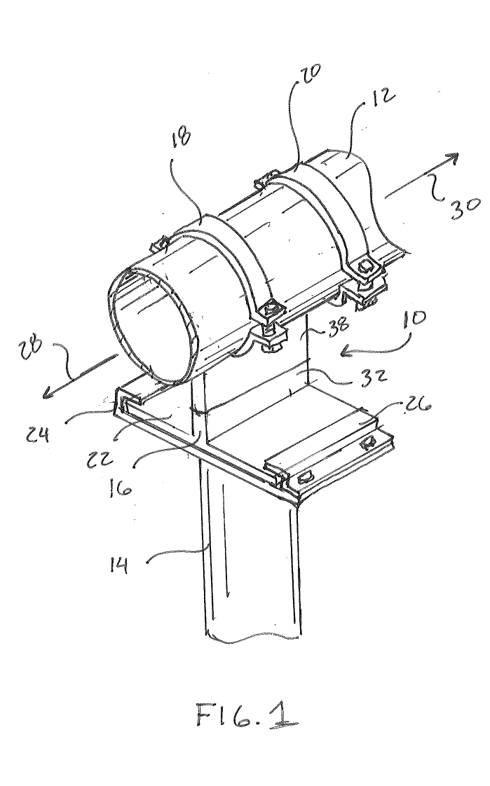

As illustrated in FIG. 1, embodiments of the invention provide an insulated pipeline support 10 used to releasably hold a pipeline 12 to piling 14 and permits longitudinal movement of the pipeline relative to the support piling.

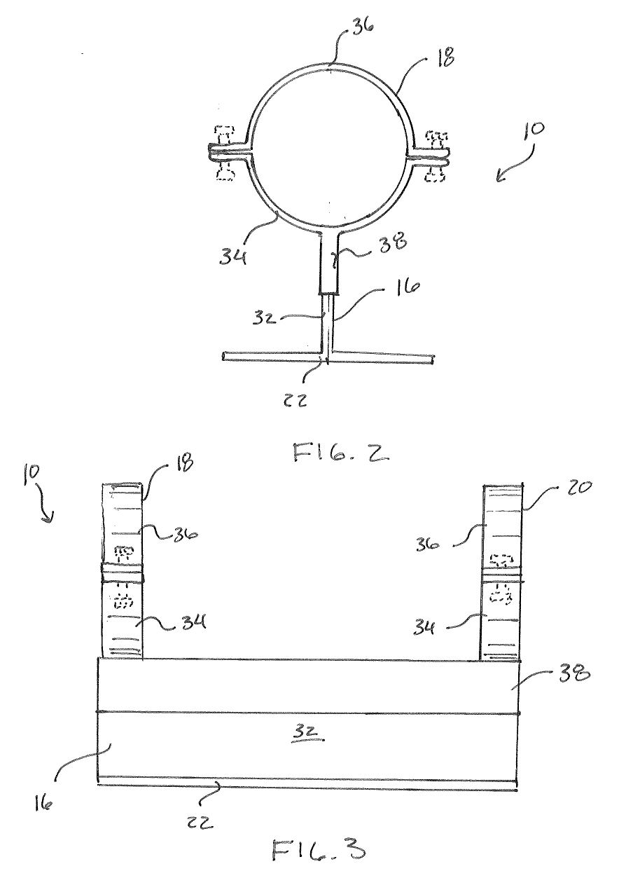

Referring to FIGS. 1-3, the pipeline support 10 includes a T-shaped base or pipe shoe 16 and two saddle clamps 18 and 20 and is made of metal. The pipe shoe 16 includes a horizontal web-portion 22 and a vertical I-portion 32 that extends upwardly from the web portion 22 and along the length of the web-portion. The pipe shoe 16 is attached to the top of the support piling 14 by positioning the web portion in a sliding relationship between opposed dog ears 24 and 26 of the support piling. To this end, the pipe shoe 16 is able to move longitudinally in a direction along the length of the pipeline 12, as generally indicated by arrows 28 and 30 with thermal expansion and contraction of the pipeline.

Saddle clamps 18 and 20 removably secure the pipeline 12 to the pipe shoe 16. Each saddle clamp 18 and 20 is made of metal and includes a lower saddle bar 34 and an upper saddle bar 36 that are secured at their respective, opposite ends by a bolted connection, sandwiching the pipeline between them. The lower saddle bar 34 of each saddle clamp 18 and 20 is conjoined with the top edge of the I-portion 32 at a spaced distance between one another along the length of the I-portion. The lower saddle bars 34 may be conjoined with the top edge of the I-portion 32 by welding the lower saddle bars 34 to the shoe, for example.

The saddle clamps 18 and 20 and an upper half of the I-portion 32 of the pipe shoe are substantially coated with a coating 38. In a preferred embodiment, at least the web-portion 22 is free of coating 38. Coating 38 thermally and electrically insulates the pipeline 12 from the support piling, and also dampens pipeline vibrations. Coating 38 can be composed of any suitable thermal and electrical insulating material that is capable of withstanding the weight of the pipeline without crushing. A suitable material is synthetic-rubber, for example, that remains flexible in extreme weather conditions. For example, plastisols are suitable material for coating 38. Coating 38 can be applied by spray coating, dip coating, combination of spray and dip coating, or by other suitable coating methods.

1. An insulating pipeline support, comprising:
a pipe shoe;
a pipeline clamp attached to said pipe shoe; and
a coating of an electrical insulator material substantially covering said pipeline clamp and an upper half of said pipe shoe.

2. The insulating pipeline support of claim 1, wherein said pipe shoe is T-shaped.

3. The insulating pipeline support of claim 1, wherein said pipeline clamp is a saddle clamp.

4. The insulating pipeline support of claim 3, wherein said saddle clamp includes an upper and lower saddle bar.

5. An insulating pipeline support, comprising:
a T-shaped pipe shoe including a horizontal web-portion and a vertical I-portion extending from said horizontal web-portion;
a first and second pipeline clamp attached to an edge of said vertical I-portion that is opposite of said horizontal web-portion, said first and second pipeline clamps spaced from one another along said edge; and
a coating of an electrical insulator material substantially covering each of said first and second pipeline clamps and an upper half of said I-portion.

6. The insulating pipeline support of claim 5, wherein each of said first and second pipeline clamps are saddle clamps.

7. The insulating pipeline support of claim 6, wherein each saddle clamp includes an upper and lower saddle bar.

8. The insulating pipeline support of claim 5, wherein said web-portion is free of said coating.

9. An assembly comprising:
a support piling;
a pipeline support including:
a pipe shoe connected to said support piling;
a pipeline clamp attached to said pipe shoe;
a coating of an electrical insulator material substantially covering said pipeline clamp and an upper half of said pipe shoe; and
a pipeline secured by said pipeline clamp.

10. The assembly of claim 9, wherein said pipe shoe is moveably connected to said support piling to move with thermal expansion and contraction with said pipeline.

11. The assembly of claim 9, wherein said pipeline clamp is a saddle clamp.

12. The assembly of claim 11, wherein said saddle clamp includes an upper and a lower saddle bar positioned along opposite sides of said pipeline.

13. The assembly of claim 9, wherein said pipe shoe is T-shaped and includes a horizontal web-portion and a vertical I-portion extending from said horizontal web portion, said horizontal web-portion being slidingly disposed between opposite dog ears of said support piling.

14. The assembly of claim 9, wherein said web-portion is free of said coating.
